(19) United States
(12) Patent Application Publication
(10) Pub. No.: US 2008/0228439 A1
(43) Pub. Date: Sep. 18, 2008

(54) Method and apparatus for measuring distance with graphic data

(75) Inventors: Jun Makihara, Kasugai (JP); Yoshio Ito, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/073,897

(22) Filed: Mar. 11, 2008

(30) Foreign Application Priority Data
Mar. 14, 2007 (JP) 2007-065344

(51) Int. Cl. G01B 21/02

(52) U.S. Cl. 702/158

(57) ABSTRACT

A computer-implemented method for facilitating measurement of the distance between edges graphically shown on a display device according to graphic data. The method includes setting a ruler including a first end point and a second end point on the edges, calculating the distance between the first end point and the second end point, moving the ruler on the display device in response to an input of a coordinate, and calculating the distance between the first end point and the second end point for the moved ruler.

### CROSS-REFERENCE TO RELATED APPLICATIONS

This application is based upon and claims the benefit of priority from the prior Japanese Patent Application No. 2007-065344, filed on Mar. 14, 2007, the entire contents of which are incorporated herein by reference.

### BACKGROUND OF THE INVENTION

1. Field

The present disclosure relates to a method and an apparatus for measuring distance between graphic edges (boundary lines) shown on a display device.

2. Description of the Related Art

When manufacturing a semiconductor integrated circuit, a wafer image subsequent to an exposure process is generated in a light intensity simulation, and the wafer image (circuit image) is shown on a display device, such as a viewer. Then, a person, or inspector, looks at the wafer image to conduct a graphic inspection. There is a demand for increasing efficiency in such graphic inspections.

The graphic inspection includes the measurement of the distance between two positions in the wafer image shown on a display screen in an enlarged state. A ruler, which is an inspection tool, is used to measure the distance.

For example, when measuring the distance (interval or width) between two positions, the inspector uses a mouse to move a cursor on the display screen showing the wafer image between two desired positions (measurement positions). At the two positions, the inspector clicks the mouse device to designate an initial point and a terminal point of the ruler. The distance between the designated initial point and terminal point is calculated by a computer, and the calculated distance is displayed on the display screen. The inspector repeats the operation for designating the initial point and terminal point to measure the distance (interval or width) between various positions in the displayed graphic.

When measuring the interval between rectangular patterns formed only by lines extending along an X axis and a Y axis, the interval can easily be measured by, for example, designating the initial point and terminal point of the ruler so that the ruler is orthogonal to each rectangular pattern. When the inspector designates an initial point on a graphic edge in the display screen, a measurement line is extended from the initial point along the X axis or the Y axis. The computer calculates the distance between the initial point and a point at which the measurement line intersects a further graphic edge.

If the measured distance differs from the designed value, a light intensity simulation is performed under different conditions to generate a new wafer image. Then, the above-described distance measurement is repeated on the new wafer image.

Japanese Laid-Open Patent Publication No. 3-15931 describes an input device for designating two positions on a digitizer with a cursor device to generate a line extending between the two designated positions. The line is shown on the digitizer.

### SUMMARY

One aspect of the present invention is a computer-implemented method for measuring distance between edges graphically shown on a display device according to graphic data. The method includes setting a ruler including a first end point and a second end point on the edges, calculating the distance between the first end point and the second end point, moving the ruler on the display device in response to an input of a coordinate, and calculating the distance between the first end point and the second end point for the moved ruler.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing a distance measurement apparatus of an embodiment;

FIG. 2 is a flowchart showing the operation of the distance measurement apparatus;

FIG. 4 is a flowchart showing step S1 of FIG. 2 in detail;

FIG. 5 is a flowchart showing step S3 of FIG. 2 in detail;

FIG. 6 is a flowchart showing step S4 of FIG. 2 in detail;

FIG. 7 is a flowchart showing step S8-c of FIG. 6 in detail;

FIG. 8 is a flowchart showing step S8-d of FIG. 6 in detail;

FIG. 9 is a flowchart showing step S10 of FIG. 2 in detail;

FIG. 10 is a flowchart showing step S10-b of FIG. 10 in detail;

FIG. 11 is a flowchart showing step S10-b-c of FIG. 10 in detail;

FIG. 12 is a flowchart showing step S10-c of FIG. 9 in detail;

FIG. 13 is a flowchart showing step S10-d of FIG. 9 in detail;

FIG. 14 is a flowchart showing step S10-e of FIG. 9 in detail;

FIG. 15 is a flowchart showing step S10-f of FIG. 9 in detail; and

FIGS. 16(a) to 16(d), 17(a), 17(b), 18(a), 18(b), 19(a), 19(b), 20(a), and 20b(b) each show a partially enlarged view of a screen shot on a display device of the distance measurement apparatus.

### DETAILED DESCRIPTION OF THE PREFERRED EMBODIMENTS

A wafer image generated in a light intensity simulation may include a curved graphic edge. The curved graphic edge is shown as a line formed by diagonally and continuously connecting many straight lines. Thus, the curved graphic edge is shown as a line that is approximate to a curve rather than a smooth curve. In order to measure a maximum or minimum distance between a curved graphic edge and another graphic edge, the two positions defining the maximum or minimum distance must be located in the curved graphic edge and the other graphic edge. Normally, an inspector would have difficulty in performing this task. Further, each position defining the maximum distance or the minimum distance would not necessarily be located on a measurement line extending along the X axis or the Y axis.

Therefore, the inspector must designate the initial and terminal points of the ruler at a plurality of measurement positions on the graphic edge to take distance measurements and find the maximum distance or the minimum distance. Further, distances must be measured at many measurement positions in order to determine whether the measured distance is truly the maximum distance or the minimum distance. Accordingly, the designation of the initial and terminal points of the ruler must be repeated many times to measure the maximum distance and the minimum distance. Such measurements are burdensome.

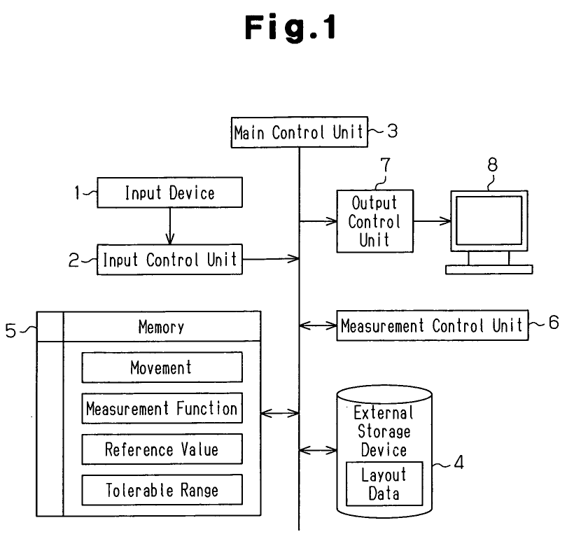

An embodiment of the present invention will now be discussed. FIG. 1 shows a block diagram of a distance measurement apparatus. An input device 1 includes a pointing device, such as a mouse, and a keyboard. The input device 1 provides an operation signal to a main control unit 3 via an input control unit 2.

Layout data is prestored in an external storage device 4. The layout data is graphic data generated in a light intensity simulation. For example, a light intensity simulation is performed based on predetermined parameters and layout data for manufacturing a semiconductor device to generate graphic data, which includes graphic images.

Data that is necessary for measuring the distance between two positions designated on a screen showing the graphic image is prestored in a memory 5. The data includes data for determining how to move a ruler, data for setting a measurement function, data for setting a reference value, and data for setting a tolerable range. The distance that is measured in the present disclosure is a distance obtained based on the graphic data, which is generated through a simulation. For example, the distance may be an inter-element distance, intra-element distance, or inter-wiring distance taken on a semiconductor wafer.

The main control unit 3 controls a measurement control unit 6, which reads the layout data stored in the external storage device 4 and the data stored in the memory 5 to measure the distance between two positions designated in the graphic data based on the read data.

The main control unit 3 controls the measurement control unit 6 in accordance with an output signal provided from the input control unit 2. Further, the main control unit 3 provides an output control unit 7 with an operation signal, which indicates the processing operation performed by the measurement control unit 6. The output control unit 7 shows the processing operation of the measurement control unit 6 on a display device 8 in accordance with the provided operation signal.

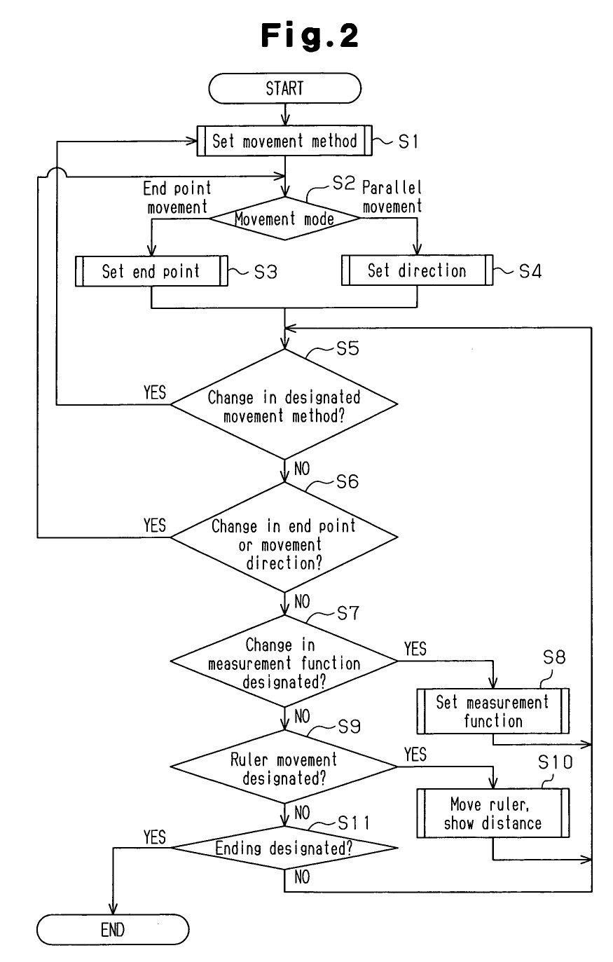

An example of a measurement of the distance between two positions designated on the screen showing the graphic image performed by the distance measurement apparatus will now be discussed. The steps illustrated in FIG. 2 are mainly controlled by the main control unit 3 and the measurement control unit 6.

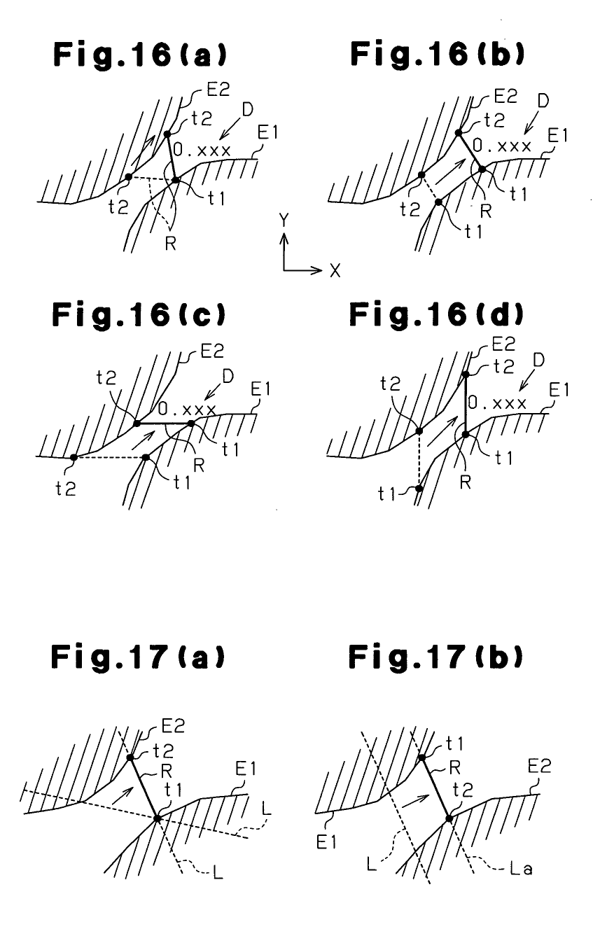

As shown in FIG. 2, in response to a processing start command, the distance measurement apparatus sets the movement method of the ruler (step S1). Step S1 will be described in detail with reference to FIG. 3. First, the display device 8 shows a pull-down menu (step S1-a). An inspector operating the distance measurement apparatus selects a movement method of end points of the ruler from the pull-down menu (step S1-b). Examples of the selectable movement methods will be described with reference to FIGS. 16(a) and 16(b). FIGS. 16(a) and 16(b) show a graphical ruler R connecting graphic edges E1 and E2. The ruler R has end points t1 and t2 respectively placed on the edges E1 and E2. In an end point movement mode shown in FIG. 16(a), only one end point (t2 in the illustrated example) is moved along the edge E2. In a parallel movement mode shown in FIG. 16(b), the end points t1 and t2 are respectively moved along the edges E1 and E2 to move the ruler R in parallel.

In step S1-b, the inspector selects the end point movement mode (step S1-c) or the parallel movement mode (step S1-d) to set the distance measurement apparatus in the selected mode.

After the setting of the movement mode is completed in step S1, the distance measurement apparatus determines the set movement mode (step S2). The process proceeds to step S3 if the end point movement mode is set. The process proceeds to step S4 if the parallel movement mode is set.

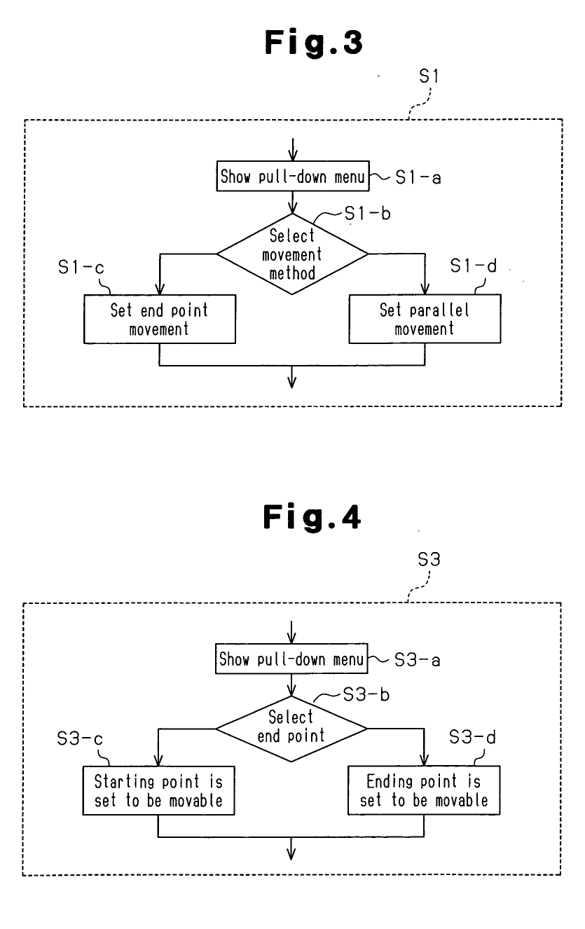

In step S3, the distance measurement apparatus, which is in the end point movement mode, sets the end point that is to be moved. Step S3 will be described in detail with reference to FIG. 4. The display device 8 shows a pull-down menu (step S3-a). The inspector selects either the initial point (i.e., end point t1 that is designated first) of the ruler R shown on the pull-down menu or the terminal point (i.e., end point t2 that is designated after the initial point) of the ruler R. For example, in the ruler shown FIG. 16(a), either one of the end point t1 and the end point t2 is selectable. If the initial point is selected in step S3-b, a mode for moving the initial point is set in the distance measurement apparatus (step S3-c). If the terminal point is selected in step S3-b, a mode for moving the terminal point is set in the distance measurement apparatus (step S3-d).

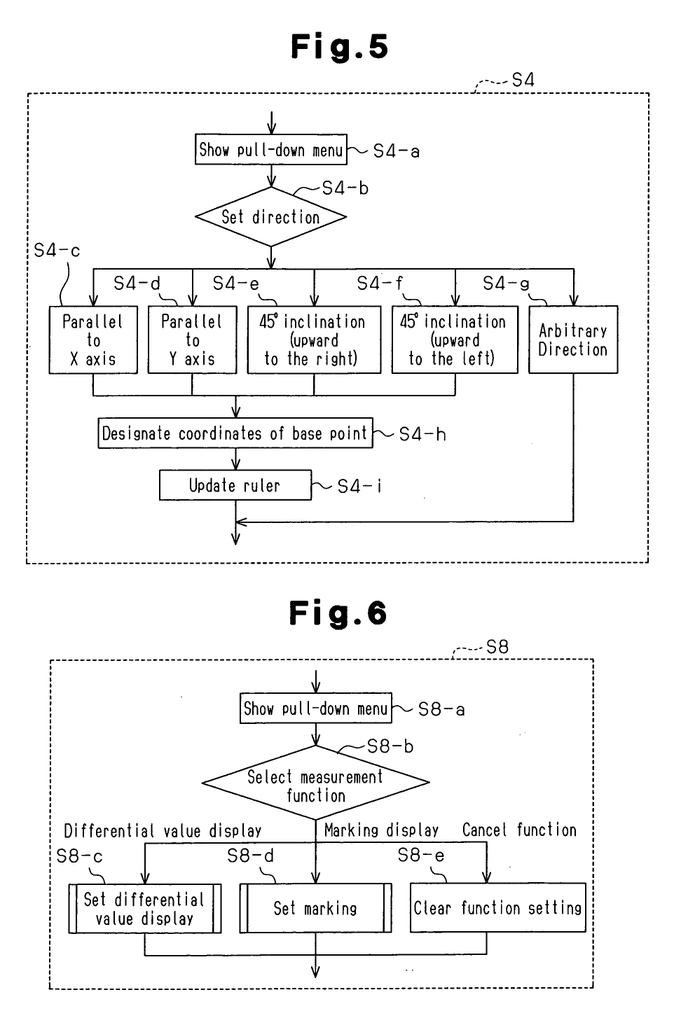

In step S4, the inspector sets the direction (inclination) of the ruler R in the parallel movement mode for the distance measurement apparatus. Step S4 will be described in detail with reference to FIG. 5. The display device 8 shows a pull-down menu (step S4-a). The inspector selects the direction (inclination) of the ruler R from among various directions shown on the pull-down menu (step S4-b).

The direction (inclination) of the ruler R that can be selected may be a direction parallel to the X axis (FIG. 16(c)), a direction parallel to the Y axis (FIG. 16(d)), a direction inclined at an angle of 45 degrees counterclockwise from the Y axis and extending upward to the left (FIG. 16(b)), a direction inclined at an angle of 45 degrees clockwise from the Y axis and extending upward to the right (not shown), and an arbitrary direction (not shown). In the present disclosure, the X axis and the Y axis are referred to as reference axes and used on a display screen of the display device 8.

If one of steps S4-c to S4-f is selected, the inspector designates the coordinates of a base point for the ruler of the distance measurement apparatus in step s4-h. The distance measurement apparatus updates the ruler R based on the designated coordinates and the selected direction (inclination) (step S4-i). The base point of the ruler R of which coordinates are set is either the initial point or the terminal point of the ruler and represents an edge point. If step S4-g is selected, steps S4-h and S4-i are skipped. The distance measurement apparatus moves the initial point and the terminal point of the ruler R along the graphic edge while maintaining the selected direction (inclination) of the ruler R to move the ruler R in parallel. In this manner, the movement direction of the ruler R is set.

After step S3 or S4 is completed, the distance measurement apparatus determines whether or not there has been a change in the movement method (step S5). If there has been a change, the process returns to step S1. If there has been no change, the process proceeds to step S6.

In step S6, the distance measurement apparatus determines whether or not there has been a change in the setting of the end point or movement direction. If there has been a change, the process proceeds to step S2. If there has been no change, the process proceeds to step S7.

In step S7, the distance measurement apparatus determines whether or not the inspector has designated a change in the measurement function. If a change has been designated, the process proceeds to step S8. If a change is not designated, the process proceeds to step S9.

In step S8, the measurement function is set or changed. Step S8 will be described in detail with reference to FIG. 6. The display device 8 shows a pull-down menu (step S8-a). The inspector selects the desiring measurement function from various selectable measurement functions presented in the pull-down menu (step S8-b). The selectable measurement functions are differential value display, marking, and cancel. If differential value display is selected, the distance measurement apparatus activates a differential value display function (step S8-c). If marking is selected, the distance measurement apparatus activates a marking function (step S8-d). If cancel is selected, the distance measurement apparatus inactivates the differential value display function and the marking function (step S8-e).

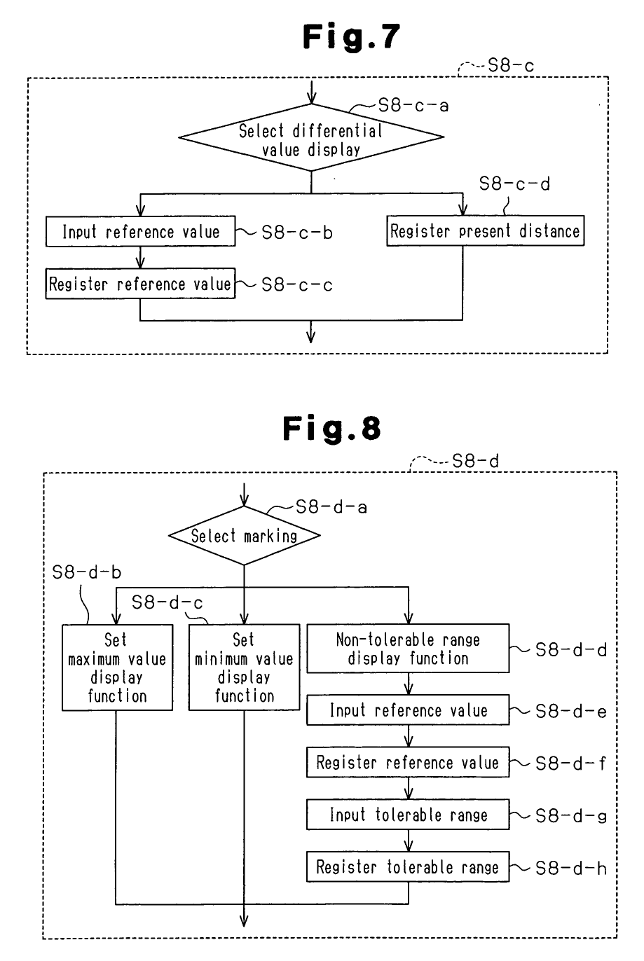

The details of activating the differential value display function in step S8-c will be described with reference to FIG. 7. The differential value display function is a function for showing the difference between a measured distance and a reference value on the display device 8 when measuring the distance between two designated positions. The selection of the differential value display is performed in step S8-c-a. The reference value for calculating the differential value is determined when selecting the differential value display. The inspector selects either to register the reference value in advance or to register an arbitrary measurement value as the reference value.

When registering the reference value in advance, the inspector inputs the reference value with the input device 1 in step S8-c-b. The distance measurement apparatus registers the input reference value (step S8-c-c).

When registering an arbitrary measurement value as the reference value, the distance measurement apparatus registers the present distance, that is, the distance between the end points of the ruler as the reference value in step S8-c-d.

The details for activating the marking function of step S8-d will now be described with reference to FIG. 8. The marking function is a function for displaying a marking on the display device 8 when the measurement value is the maximum value, the minimum value, or within a tolerable range, which is set in advance when measuring the distance between two designated positions. In step S8-d-a, the inspector selects marking display so that a marking is shown when the measured distance is the maximum value, the measured distance is the minimum value, or the measured distance is excluded from a tolerable range.

When the maximum value marking is selected in step S8-d-a, the distance measurement apparatus sets a function for displaying the measurement value when the measurement value becomes maximum in step S8-d-b. When the minimum value marking is selected in step S8-d-a, the distance measurement apparatus sets a function for displaying the measurement value when the measurement value becomes minimum in step S8-d-c.

When the non-tolerable range value marking is selected in step S8-d-a, the distance measurement apparatus sets a function for displaying a marking when the measurement value is excluded from the tolerable range in step S8-d-d. The inspector inputs the reference value with the input device 1 in step S8-d-e. Then, the distance measurement apparatus registers the input reference value (step S8-d-f). The inspector inputs the tolerable range from the input device 1 in step S8-d-g. Then, the distance measurement apparatus registers the input tolerable range (step S8-d-h).

If function cancel is selected in step S8-b, the distance measurement apparatus cancels the functions set in step S8-c and step S8-d in step S8-e. After step S8 ends, the process returns to step S5.

If a change of measurement function is not selected in step S7, the distance measurement apparatus determines whether or not movement of the ruler has been designated (step S9). If movement of the ruler has been designated, the distance measurement apparatus moves the ruler, measures the distance, and shows the distance in step S10.

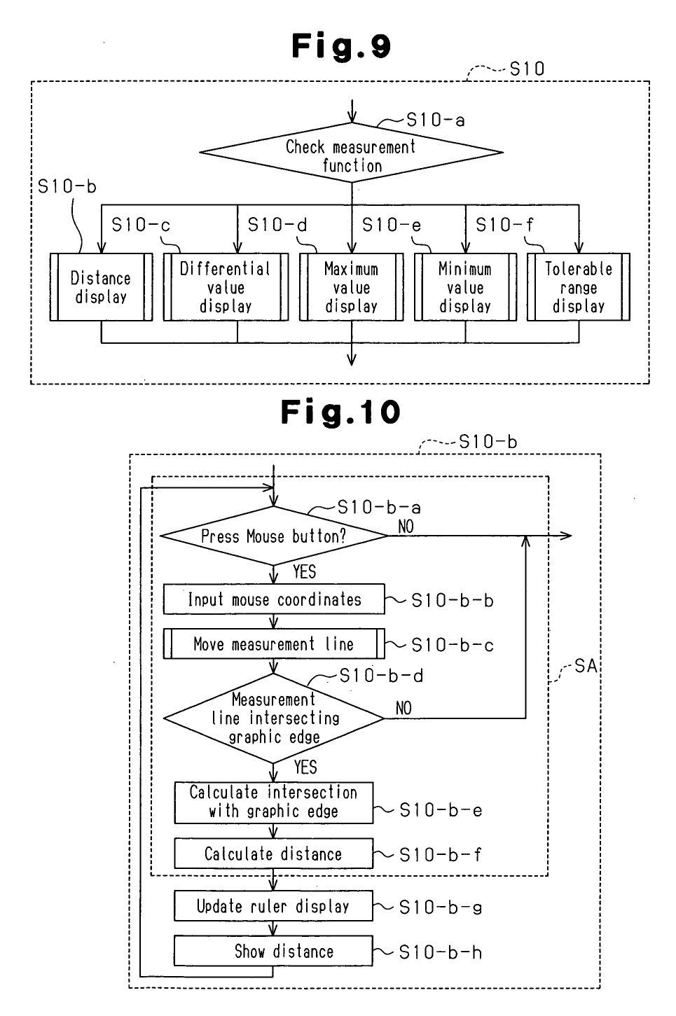

The details of step S10 will now be described with reference to FIGS. 9 to 15.

In step S10-a of FIG. 9, the distance measurement apparatus checks the measurement function set in step S8. The distance measurement apparatus performs at least one of a distance display setting (step S10-b), a differential value display setting (step S10-c), a maximum value display setting (step S10-d), a minimum value display setting (step S10-e), or a tolerable range display setting (step S10-f) in correspondence to the set measurement function.

The details of the distance display setting of step S10-b will be described with reference to FIG. 10. The inspector moves the cursor to a desired position on the display device 8 and then presses a mouse button at that position (step S10-b-a). In response to the button operation, the distance measurement apparatus obtains the coordinates of the cursor device (step S10-b-b). Then, the distance measurement apparatus moves the measurement line in step S10-b-c.

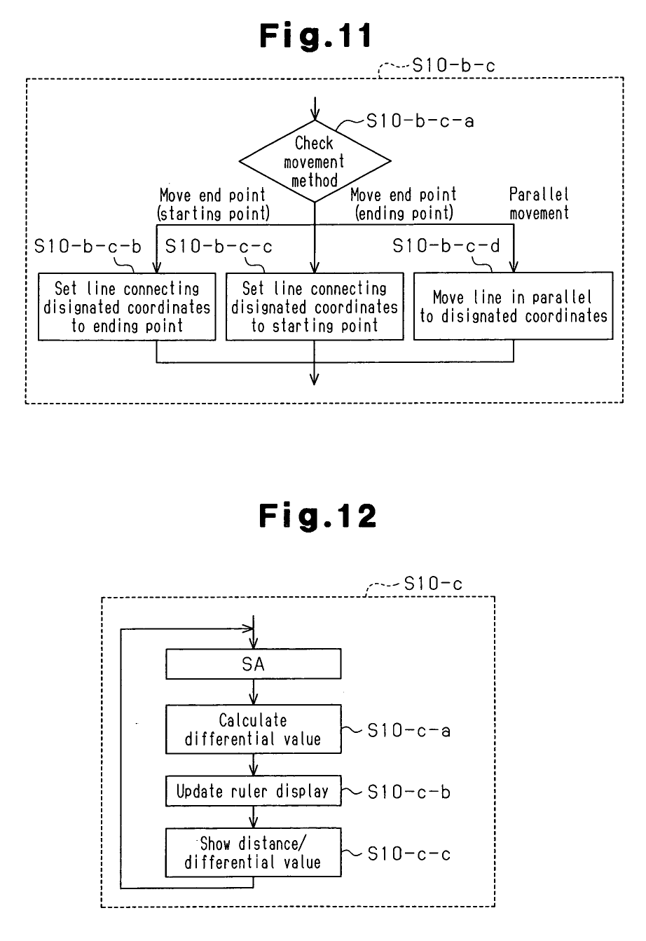

The details of the movement of the measurement line in step S10-b-c is shown in FIG. 11. In step S10-b-c-a, the distance measurement apparatus checks the selected movement method. If the end point movement mode is set in step S1-c and the initial point is set to be movable in step S3-c, the distance measurement apparatus generates a line connecting the coordinates obtained in step S10-b-b to the terminal point and sets that line as the measurement line in step S10-b-c-b.

If the end point movement mode is set in step S1-c and the terminal point is set to be movable in step S3-d, the distance measurement apparatus generates a line connecting the coordinates obtained in step S10-b-b to the initial point and sets that line as the measurement line in step S10-b-c-c.

If the parallel movement mode is set in step S1-d, the distance measurement apparatus moves the measurement line in parallel to the coordinates obtained in step S10-b-b in accordance with the movement direction set in step S4 (step S10-b-c-d).

After moving the measurement line, the distance measurement apparatus determines whether or not the measurement line intersects a graphic edge in step S10-b-d. When determining that the measurement line intersects the graphic edge, the distance measurement apparatus obtains the coordinates of the intersecting point of the measurement line and the graphic edge (step S10-b-e) to calculate the distance between the intersecting point and the initial point or terminal point (step S10-b-f). When determining that the measurement line does not intersect a graphic edge in step S10-b-d, the process returns to step S5.

Whenever the measurement line is moved, the distance measurement apparatus updates the display of the ruler (step S10-b-g), displays the distance between the end points of the ruler on the display device 8 (step S10-b-h), and then waits until the mouse button (step S10-b-a) is pressed again. When the pressing of the mouse button ends in step S10-b-a, the process returns to step S5.

The details of the differential value display setting of step S10-c will be described with reference to FIG. 12. In step S10-c, the distance measurement apparatus performs a series of processes SA, which include steps S10-b-a to S10-b-f shown in FIG. 10, to measure the distance between the end points of the ruler. Then, the distance measurement apparatus calculates the differential value from the measurement value and the reference value set in step S8-c (step S10-c-a).

Whenever the measurement line is moved, the distance measurement apparatus updates the display of the ruler (step S10-c-b), displays the differential value of the distance between the end points of the ruler on the display device 8 (step S10-c-c), returns to processes SA, and then waits until the mouse button is pressed again.

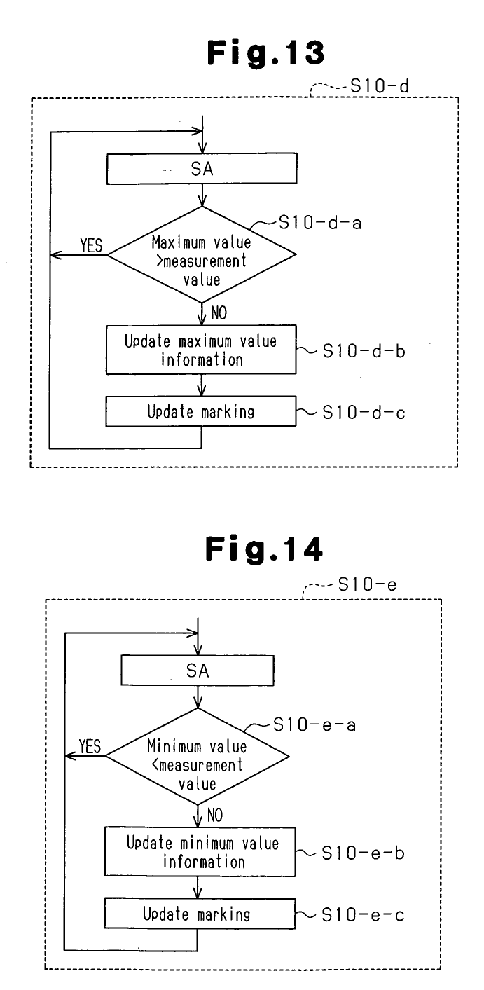

The details of the maximum value display setting of step S10-d will be described with reference to FIG. 13. The distance measurement apparatus first performs a series of processes SA, which includes steps S10-b-a to S10-b-f shown in FIG. 10, to measure the distance between the end points of the ruler. The distance measurement apparatus compares the measurement value and a maximum value (step S10-d-a). Specifically, the measurement value calculated when the mouse button is pressed is compared with a maximum value (finally updated value or temporary maximum value) of previously calculated measurement values.

If the new measurement value is smaller than the final updated maximum value, the distance measurement apparatus repeats processes SA. If the new measurement value is greater than the finally updated maximum value, the distance measurement apparatus updates the maximum value in step S10-d-b. Further, the distance measurement apparatus updates the marking showing the ruler at a position corresponding to the updated new maximum value in step S10-d-c.

The details of the minimum value display setting of step S10-e will be described with reference to FIG. 14. The distance measurement apparatus first performs a series of processes SA, which includes steps S10-b-a to S10-b-f shown in FIG. 10, to measure the distance between the end points of the ruler. The distance measurement apparatus compares the measurement value and a minimum value (step S10-e-a). Specifically, the measurement value calculated when the mouse button is pressed is compared with the minimum value (finally updated value or temporary minimum value) of previously calculated measurement values.

If the new measurement value is greater than the final updated minimum value, the distance measurement apparatus repeats processes SA. If the new measurement value is less than the final updated minimum value, the distance measurement apparatus updates the minimum value in step S10-e-b. Further, the distance measurement apparatus updates the marking showing the ruler at a position corresponding to the updated new minimum value in step S10-e-c.

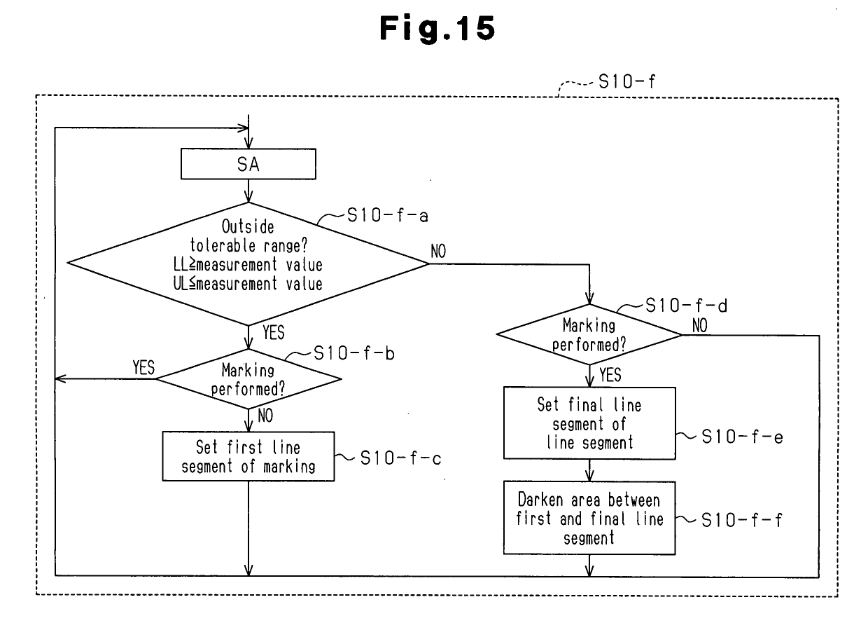

The details of the tolerable range display setting of step S10-f will be described with reference to FIG. 15. The distance measurement apparatus first performs a series of processes SA, which includes steps S10-b-a to S10-b-f shown in FIG. 10, to measure the distance between the end points of the ruler. The distance measurement apparatus determines whether or not the measurement value is within the tolerable range. Specifically, the distance measurement apparatus compares the measurement value with a lower limit value (LL) and an upper limit value (UL) set in step S8-d to determine whether or not the measurement value is within the tolerable range between the lower limit value and the upper limit value. If the measurement value is within the tolerable range (NO), the distance measurement apparatus determines whether or not marking is being performed (step S10-f-d). In marking is not being performed (YES), processes SA are repeated.

When the measurement value becomes excluded from the tolerable range after being continuously included in the tolerable range (step S10-f-a), the distance measurement apparatus determines whether or not marking is being performed (step S10-f-b). If marking is not being performed, the distance measurement apparatus sets a first line segment (L1 of FIG. 20) of a marking at that position (step S10-f-c) and then repeats processes SA. If marking is being performed, processes SA are repeated.

If the measurement value again enters the tolerable range after being continuously excluded from the tolerable range, the distance measurement apparatus determines whether or not marking is being performed in step S10-f-d. If marking is being performed, the distance measurement apparatus sets a last line segment (L2 of FIG. 20) of the marking at the position immediately before the present position (step S10-f-e) and darkens an area between the first line segment and the last line segment to indicates that this area is outside the tolerable range (step S10-f-f). Then, processes SA are repeated.

After designation of the ruler movement is ended in step S9, the process proceeds to step S11. If the ending of all the measurement processes is not designated in step S11, the process returns to step S5. If the ending of all the measurement processes is designated, the operation of the distance measurement apparatus ends.

An example of how the distance between the graphic edges E1 and E2 is measured will now be discussed.

In the example of FIG. 16(a), t2, which is the terminal point of the end points t1 and t2 of the ruler R, is moved along the graphic edge E2. The distance D between the end points t1 and t2 that changes as the end point t2 moves is calculated and displayed on the display device 8.

This example is a case in which the inspector sets the end point movement mode in step S1 (step S1-c), sets the terminal point to be movable in step S3 (step S3-d), and sets the distance display in step S10 (step S10-b).

The end point t2 moves along the edge E2, and the ruler R pivotally moves about the end point t1 whenever the inspector clicks the mouse button. The distance D between the end points t1 and t2 is displayed on the display device 8 at each moved position.

In the example of FIG. 16(b), the ruler R is moved in parallel. The distance D between the end points t1 and t2 that changes as the ruler R moves is calculated and displayed on the display device 8.

This example is a case in which the inspector sets the parallel movement mode in step S1 (step S1-d), sets the direction (inclination) of the ruler R as an arbitrary direction in step S4 (step S4-g), and sets the distance display in step S10 (step S10-b).

The ruler R moves in parallel whenever the inspector clicks the mouse button. The distance D between the end points t1 and t2 is displayed on the display device 8 at each moved position.

In the example of FIG. 16(c), the ruler R is moved in parallel while maintaining the longitudinal direction of the ruler R in the X axis direction. The distance D between the end points t1 and t2 that changes as the ruler R moves is calculated and displayed on the display device 8.

This example is a case in which the inspector sets the parallel movement mode in step S1 (step S1-d), sets the X axis direction in step S4 (step S4-c), and sets the distance display in step S10 (step S10-b).

The end points t1 and t2 of the ruler move along the edges E1 and E2 while maintaining the longitudinal direction of the ruler R in the X axis direction so that the ruler R moves in parallel whenever the inspector clicks the mouse button. The distance D between the end points t1 and t2 is displayed at each moved position on the display device 8.

In the example of FIG. 16(d), the ruler R is moved in parallel while maintaining the longitudinal direction of the ruler R in the Y axis direction. Changes in the distance D between the end points t1 and t2 as the ruler R moves are calculated and displayed on the display device 8.

This example is a case in which the inspector sets the parallel movement mode in step S1 (step S1-d), sets the Y axis direction in step S4 (step S4-d), and sets the distance display in step S10 (step S10-b).

The end points t1 and t2 of the ruler move along the edges E1 and E2 while maintaining the longitudinal direction of the ruler R in the Y axis direction so that the ruler R moves in parallel whenever the inspector clicks the mouse button. The distance D between the end points t1 and t2 is displayed at each moved position on the display device 8.

FIGS. 17(a) and 17(b) show a process for moving the ruler R in step S10.

FIG. 17(a) shows a process performed when the end point movement mode is set in step S1. The end point t1 is maintained in a fixed state, and the end point t2 is moved along the graphic edge E2.

The intersecting points between the measurement line L and the graphic edges E1 and E2 are displayed as end points t1 and t2 on the display device 8. The line segment between the intersecting points is displayed as the ruler R on the display device 8. The distance measurement apparatus obtains a measurement line L connecting the coordinates of a position at which the mouse button is clicked and the fixed end point t1. Further, the distance measurement apparatus obtains the intersecting point of the measurement line L and the graphic edge E2. The ruler R with this intersecting point, or the end point t2, is displayed on the display device 8.

FIG. 17(b) shows a process that is performed when the parallel movement mode is set in step S1. The measurement line L is set to be inclined by 45 degrees counterclockwise from the Y axis. When the operator clicks the mouse button at an arbitrary cursor position in such a state, a new measurement line La parallel to the original measurement line L and including the coordinates (passing through the coordinate) of the position designated by the clicking is obtained. The intersecting points of the measurement line La and the graphic edges E1 and E2 are calculated. A ruler having these intersecting points, or end points t1 and t2, is displayed on the display device 8.

The measurement lines L and La are set to generate the ruler R (end points t1 and t2) and are not displayed on the display device 8.

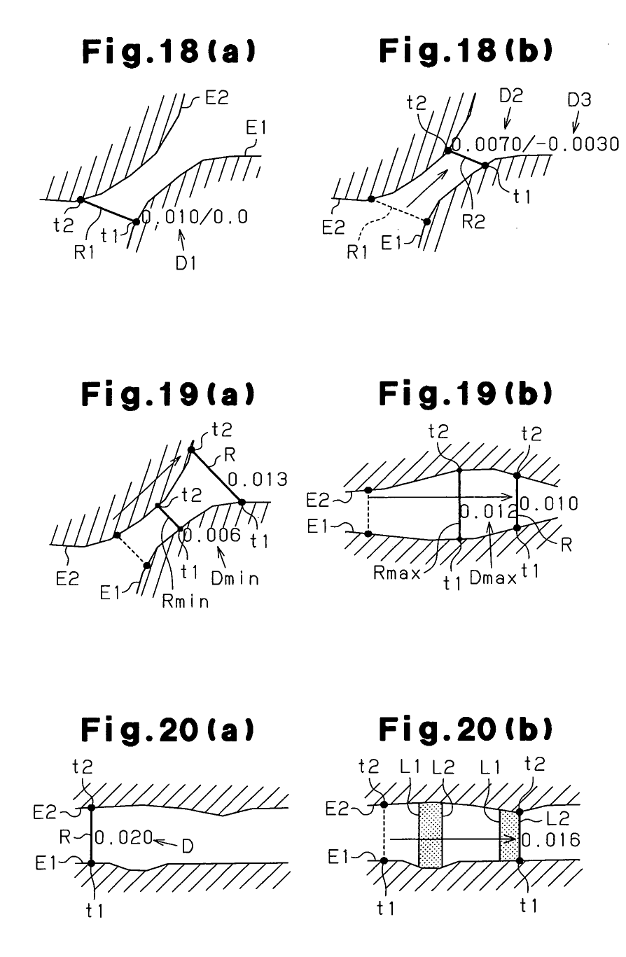

FIGS. 18(a) and 18(B) show a measurement method for displaying the distance D between the end points t1 and t2 in addition to the differential value while moving the ruler R in parallel.

This example shows a case in which the inspector sets the parallel movement mode in step S1 (step S1-d), sets the direction (inclination) of the ruler R in the arbitrary direction in step S4 (step S4-g), performs the setting of the differential value display in step S8 (step S8-c), and sets the differential value display in step S10 (step S10-c).

As shown in FIG. 18(a), the distance D1 of “0.010” between the end points t1 and t2 of a ruler R1 is calculated and displayed on the display device 8 when the inspector clicks the mouse button and sets the reference ruler R1. The distance D1 of the reference ruler R may be referred to as a reference distance. At this point of time, the differential value from the reference distance is “0.0”. When the inspector clicks the mouse button and moves the ruler R1 in parallel to set a new ruler R2, the distance D2 between the end points t1 and t2 of the ruler R2 and the differential value D3 are displayed in response to such operation (FIG. 18(b)). The differential value D3, which indicates the amount of change between the reference distance (D1) and the distance D2, takes a positive value, negative value, or zero.

FIGS. 19(a) and 19(b) show a method of marking a ruler at the position of minimum distance or maximum distance while moving the ruler in parallel and measuring the distance between the graphic edges E1 and E2.

This example shows a case in which the inspector sets the parallel movement mode in step S1 (step S1-d), sets the direction (inclination) of the ruler R in step S4, performs the setting of the marking in step S8 (step S8-d), and sets the maximum value display or the minimum display device in step S10 (step S10-d or step S10-e).

FIG. 19(a) shows a case in which the minimum value display is set in step S10. When the ruler R is moved in parallel, distances between the end points t1 and t2 of rulers R are sequentially calculated. A ruler Rmin is marked and continuously displayed on the display device 8 at the position where the measurement value is minimum. The minimum distance Dmin is displayed with the ruler Rmin.

FIG. 19(b) shows a case in which the maximum value display is set in step S10. When the ruler R is moved in parallel, distances between the end points t1 and t2 of rulers R are sequentially calculated. A ruler Rmax is marked and continuously displayed at the position where the measurement value is maximum. The maximum distance Dmax is displayed with the ruler Rmax.

FIGS. 20(a) and 20(b) show a method of performing marking and displaying when the measurement value exceeds the tolerable range while moving the ruler in parallel and measuring the distance between the graphic edges E1 and E2.

This example shows a case in which the inspector sets the parallel movement mode in step S1 (step S1-d), sets the direction (inclination) of the ruler R in step S4, performs setting of the marking in step S8 (step S8-d), and sets the tolerable range display in step S10 (step S10-f).

Referring to FIG. 20(a), when the inspector operates the mouse and moves the ruler R in parallel from the initial position, portions at which the distance D between the end points t1 and t2 become excluded from the tolerable range are shown in a darkened state between line segments L1 and L2.

In the examples of FIGS. 19(a), 19(b), 20(a), and 20(b), the distance measurement apparatus successively calculates and holds the distance while continuously moving the end points t1 and t2 on the edges E1 and E2. Thus, the maximum and minimum distance values can easily be designated.

The distance measurement apparatus of the embodiment has the advantages described below.

(1) One of the end points t1 and t2, which are the initial point and the terminal point of the ruler, may be performed to measure the distance between t1 and t2. Further, the ruler may be moved in parallel to measure the distance between the end points t1 and t2. Accordingly, the initial point and the terminal point of the ruler do not need to be repeatedly set when measuring the maximum value or the minimum value of the distance between the end points t1 and t2. This facilitates the measurement.

(2) Either one of the initial point and the terminal point of the ruler may be fixed, and the other point may be moved along a graphic edge to measure the distance between the initial point and the terminal point. Further, the measurement value of the distance may be shown on the display device 8. Accordingly, the minimum value and the maximum value of the distance between the initial point and the terminal point of the ruler are easily measured.

(3) The ruler is moved in parallel to measure the distance between the initial point and the terminal point. Further, the measurement value is shown on the display device 8. Therefore, the minimum and maximum values of the distance between the initial point and the terminal point of the ruler are easily measured.

(4) When moving the ruler in parallel, the angle (inclination) of the ruler with respect to the reference axis (X axis or Y axis) on the display screen may be selected. The ruler is moved in parallel while maintaining the selected angle. Therefore, the maximum and minimum values of the distance between the graphic edges is easily measured.

(5) When displaying the distance between the initial point and the terminal point of the ruler on the display device 8, the differential value from the reference value, which is set in advance, may be displayed.

(6) By setting the marking, the ruler is fixed and displayed at the position where the distance between the initial point and the terminal point becomes maximum or minimum. Therefore, the position where the distance between the initial point and the terminal point of the ruler becomes maximum or minimum is easily detected, and the distance therebetween can be measured.

(7) The tolerable range display setting shows portions where the distance between the initial point and the terminal point of the ruler become excluded from the tolerable range on the display device 8 when the ruler is moved in parallel. Accordingly, portions where the distance between the graphic edges becomes excluded from the tolerable range can easily be identified.

The embodiment may be modified as described below.

The difference (amount of change) in distance before and after movement may be continuously shown on the display device 8 while successively moving the end point and successively measuring the distance.

The ruler position at which the measurement value becomes maximum or minimum may be marked on the display device 8 while successively moving the end point and successively measuring the distance.

The present examples and embodiments are to be considered as illustrative and not restrictive, and the invention is not to be limited to the details given herein, but may be modified within the scope and equivalence of the appended claims.

What is claimed is:

1. A computer-implemented method for measuring distance between edges graphically shown on a display device according to graphic data, the method comprising:
setting a ruler including a first end point and a second end point on the edges;
calculating the distance between the first end point and the second end point;
moving the ruler on the display device in response to an input of a coordinate; and
calculating the distance between the first end point and the second end point for the moved ruler.

2. The method according to claim 1, further comprising:
fixing one of the first end point and second end point;
obtaining a measurement line connecting the input coordinate and the fixed end point;
obtaining an intersecting point of the measurement line and one of the edges;
setting the obtained intersecting point as the other one of the first end point and second end point; and
calculating the distance between the fixed one of the end points and the set other one of the end points.

3. The method according to claim 1, further comprising:
calculating a measurement line including the input coordinate and being parallel to a reference ruler that is set in advance;
calculating intersecting points of the measurement line and the edges; and
setting the calculated intersecting points as end points of the ruler; and
calculating the distance between the set end points.

4. The method according to claim 2, further comprising:
showing the distance between the calculated end points as a measurement value on the display device.

5. The method according to claim 3, further comprising:
moving the reference ruler while maintaining an angle between a longitudinal direction of the reference ruler and a reference axis used on a display screen of the display device at a predetermined value, with the predetermined value being selectable.

6. The method according to claim 4, further comprising:
showing on the display device the difference between the measurement value and a reference value that is set in advance.

7. The method according to claim 4, further comprising:
marking the ruler and the measurement value at a position where the measurement value is maximum or minimum.

8. The method according to claim 4, further comprising:
marking a position corresponding to the measurement value at which the measurement value exceeds a tolerable range that is set in advance.

9. The method according to claim 1, wherein the graphic data includes a circuit image of a semiconductor integrated circuit.

10. A distance measurement apparatus for graphic data, the distance measurement apparatus comprising:
an external storage device which stores the graphic data;
a display device which displays the graphic data;
an input device for use when selecting a coordinate on the display device;
a control unit which calculates the distance between end points of a ruler arranged between graphic edges contained in the graphic data; and
a measurement control unit which moves the ruler on the display device based on the selected coordinate and calculates the distance between the end points of the moved ruler.
